(19) United States
(12) Patent Application Publication
(10) Pub. No.: US 2006/0174991 A1
(43) Pub. Date: Aug. 10, 2006

(54) Pneumatic tire

(75) Inventors: Mitsuru Naito, Kanagawa (JP); Takashi Fukutomi, Kanagawa (JP); Takumi Sekiguchi, Kanagawa (JP); Issei Nakakita, Kanagawa (JP); Yuichi Kobayashi, Kanagawa (JP); Tetsuo Ikegami, Aichi (JP); Satoshi Makino, Saitama (JP); Takayuki Toyoshima, Saitama (JP)

Correspondence Address: RADER FISHMAN & GRAUER PLLC, LION BUILDING, 1233 20TH STREET N.W., SUITE 501, WASHINGTON, DC, 20036, US

(73) Assignees: THE YOKOHAMA RUBBER CO., LTD., Tokyo (JP); HONDA MOTOR CO., LTD., Tokyo (JP)

(21) Appl. No.: 10/561,950

(22) PCT Filed: Jul. 26, 2004
(86) PCT No.: PCT/JP04/10612

§ 371 Date: Dec. 22, 2005

(30) Foreign Application Priority Data
Jul. 28, 2003 (JP) 2003-202407

(51) Int. Cl. B60C 19/12

(52) U.S. Cl. 152/504; 152/502

(57) ABSTRACT

A pneumatic tire having a tread, a sealant layer for prevention of puncturing being provided on the inner surface of the tire in the tread, a rubber cover layer covering the surface of the sealant layer. The rubber cover layer is formed of rubber having a JIS A hardness X of 50 to 70, and has a thickness Y (mm) satisfying the following expression in relation to the hardness X.
−0.025X+2.25≦Y≦−0.025X+3.05

### TECHNICAL FIELD

The present invention relates to a pneumatic tire having a function of preventing puncturing thereof, and more particularly, to a pneumatic tire which can improve ability to seal against punctures.

### TECHNICAL BACKGROUND

There have been conventionally proposed various pneumatic tires having ability to seal against punctures to secure the safety of vehicles when the tires are subjected to puncture from nails or the like during driving. Among such pneumatic tires, there is a pneumatic tire having a sealant layer for prevention of puncturing provided on the inner surface of the tire in the tread, and a rubber cover layer covering the surface of the sealant layer (see Unexamined Japanese Patent Application Publication No. 2000-247122, for example).

Since the rubber cover layer covers the sealant layer as described above, when the tire punctures from, for example, a nail that has run thereinto, the sealant around the nail that has run into the tire can be drawn to thereby increase the amount of sealant adjacent the nail, which can provide a high sealing effect. Also, the tacky sealant layer is not exposed on the tire surface, which provides an advantage of easy handling of the tire.

However, pneumatic tires constructed so that the rubber cover layer covers the sealant layer, as described above, may have air leakage from a puncture hole after removal of a nail or the like that has caused puncturing.

### DISCLOSURE OF THE INVENTION

An object of the present invention is to provide a pneumatic tire capable of sealing a puncture hole more reliably.

In order to achieve the above object, the present invention provides a pneumatic tire having a tread, a sealant layer for prevention of puncturing being provided on an inner surface of the tire in the tread, a rubber cover layer covering a surface of the sealant layer, wherein the rubber cover layer is formed of rubber having a JIS A hardness X of 50 to 70, and has a thickness Y (mm) satisfying the following expression in relation to the hardness X.
−0.025X+2.25≦Y≦−0.025X+3.05

According to the present invention, when a puncturing object such as a nail is pulled out of the tire, the sealant adjacent the puncture hole comes into the puncture hole to seal it without making the rubber cover layer intrude into the puncture hole; therefore, a sealing effect of the puncture hole after removal of the puncturing object can be improved. Accordingly, the puncture hole can be sealed more reliably.

### BRIEF DESCRIPTION OF THE DRAWINGS

FIG. 1 is a main cross-sectional view showing an embodiment of a pneumatic tire according to the present invention.

FIG. 2 is across-sectional view illustrating a state where a nail has run into a tire having a sealant layer and a rubber cover layer.

FIG. 3A is a cross-sectional view illustrating a state where the nail has been pulled out of the tire shown in FIG. 2.

FIG. 3B is another cross-sectional view illustrating a state where the nail has been pulled out of the tire shown in FIG. 2.

FIG. 4 is a graph showing the relationship between the JIS A hardness X of rubber and the thickness Y of the rubber cover layer of a pneumatic tire according to the present invention.

FIG. 5 is still another cross-sectional view illustrating a state where the nail has been pulled out of the tire shown in FIG. 2.

### BEST MODES FOR CARRYING OUT THE INVENTION

An embodiment of the present invention will be described in detail below with reference to the attached drawings.

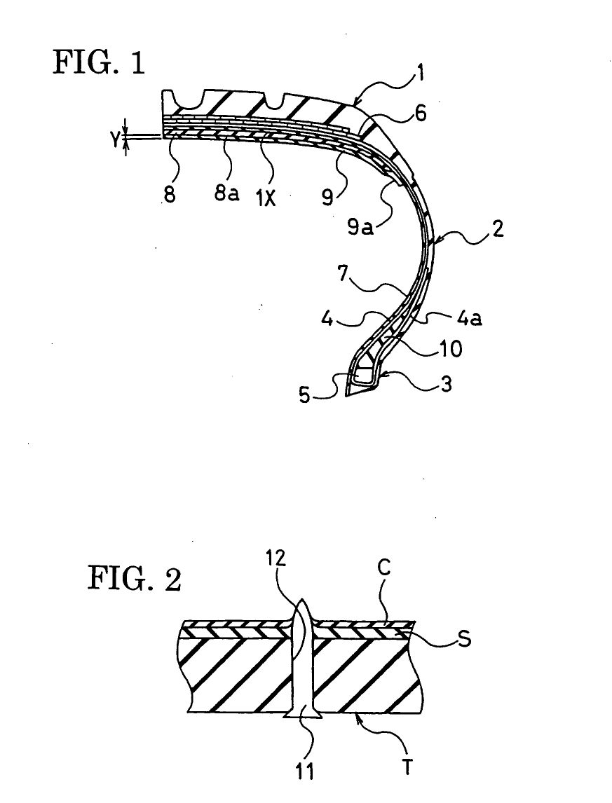

Referring to FIG. 1, reference numeral 1 denotes a tread, reference numeral 2 denotes a sidewall, and reference numeral 3 denotes a bead. A carcass ply 4 extends between the right and left beads 3, and has opposing end portions 4a that are turned up from the inner side of the tire toward the outer side thereof about bead cores 5 embedded in the beads 3 with bead fillers 10 being sandwiched. Belt plies 6 are disposed radially outwardly of the carcass ply 4 in the tread 1. An innerliner 7 is provided inwardly of the carcass ply 4.

A sealant layer 8 for prevention of puncturing is provided radially inwardly of the innerliner in the tread 1. The sealant layer 8, which is annularly disposed on the inner surface 1× of the tire in the tread 1, is formed of a conventionally well-known sealing material; examples of the sealing material preferably include rubber polymers of diene series such as butadiene, isoprene and styrene-butadiene, rubber polymers of olefin series such as copolymer of polyethylene and styrene, and gel compositions comprising these rubber polymers and paraffin oil dispersed therein as necessary.

A rubber cover layer 9 is annularly disposed radially inwardly of the sealant layer 8. The rubber cover layer 9 covers the surface 8a of the sealant layer 8, and the opposing ends 9a of the rubber cover layer 9 located in the widthwise direction of the tire are bonded to the innerliner 7. When the tire punctures from a nail of the like that has run into the tire, the rubber cover layer 9 helps draw the sealant around the nail that has run into the tire closer, providing a high sealing effect. Also, the tacky sealant layer 8 is not exposed on the tire surface, providing easy handling of the tire.

The rubber cover layer 9 described above is formed of rubber having a JIS A hardness X of 50 to 70, and the thickness Y (mm) of the rubber cover layer fulfills the following expression in relation to the hardness X.
−0.025X+2.25≦Y≦−0.025X+3.05

The present inventors have found the following through intense study and various experiments on tires in which a sealant layer is covered with a rubber cover layer in order to improve ability to seal against punctures. That is, after a nail or the like that caused puncturing has been removed, the sealant of the sealant layer seals the puncture hole, and when sealing, it has been found that the rubber cover layer has great affection thereon.

As shown in FIG. 2, when a nail 11 runs into a tire T during driving, the sealant of the sealant layer S sticks fast to the nail 11 to prevent air from leaking out through a puncture hole 12, providing a sealing effect. After the nail 11 has been removed, the sealant of the sealant layer S flows into the puncture hole so as to seal it; when the rubber cover layer C is low in stiffness, the rubber cover layer C is pulled into the puncture hole 12 with the sealant of the sealant layer S during removing of the nail 11, whereby the puncture hole 12 is sealed with a portion Ca of the rubber cover layer C intruding thereinto and existing with the sealant. Therefore, air in the tire leaks little by little from a gap created in the portion Ca that has intruded thereinto.

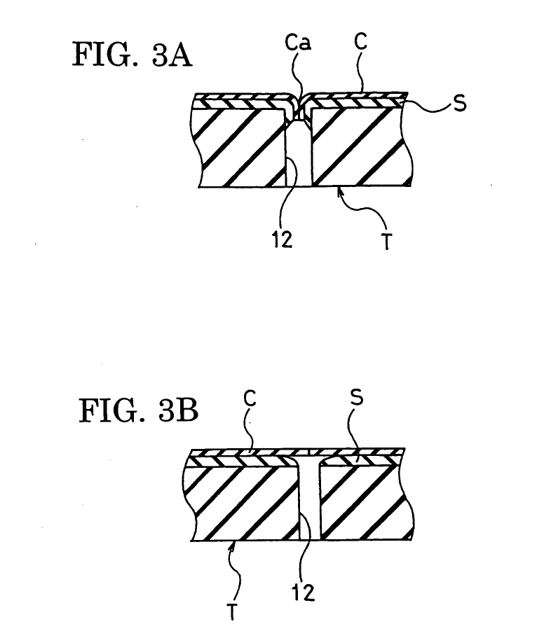

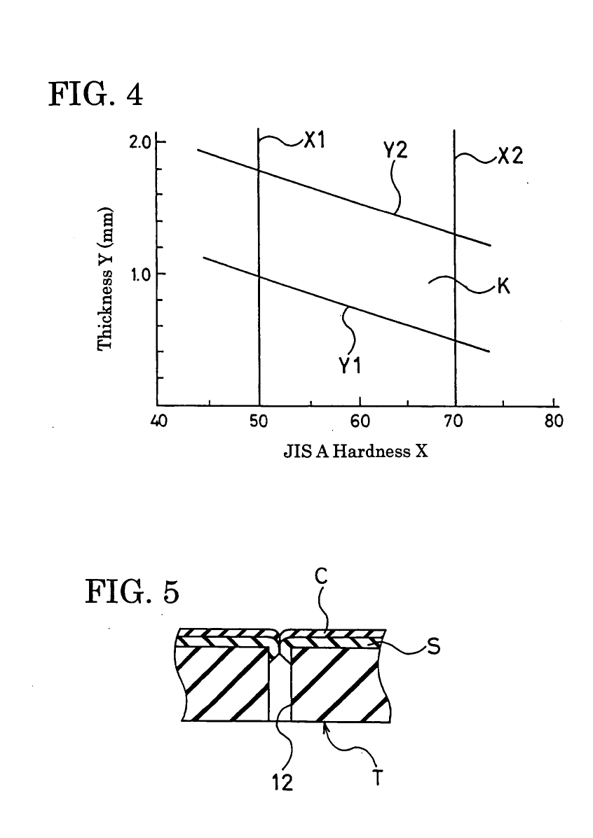

When the rubber cover layer C is high in stiffness, the sealant adjacent the puncture hole 12 sticks to the nail 12, and is removed with the nail 12 when the nail 12 is pulled out; it is also difficult to make the sealant around the puncture hole 12 flow into the puncture hole 12, and the sealant of the sealant layer S can not seal the puncture hole 12, as shown in FIG. 3B, thereby leaking air.

Based on the finding described above, the present inventors noted the hardness of rubber and the thickness of the rubber cover layer C that were factors for deciding stiffness thereof. Experiments were repeated again and again, changing the JIS A hardness of rubber used for the rubber cover layer C and the thickness thereof in various ways; as the result, if the JIS A hardness X of the rubber is plotted along the abscissa and the thickness Y along the ordinate, it has been found that a good sealing effect can be provided even after removal of a puncturing object such as a nail, when the relationship between them satisfies the range K defined by the following four straight lines.
X1=50×
X2=70
Y1=−0.025X+2.25
Y2=−0.025X+3.05

That is, a tire including a sealant layer S covered with a rubber cover layer C having a hardness and thickness defined in the range K, as described above, provides a good sealing effect, because, when the nail or the like is pulled out, the sealant adjacent the puncture hole sticks to the rubber cover layer C and remains in position, and the sealant of the sealant layer S adjacent the puncture hole 12 seals the puncture hole 12 without pulling the rubber cover layer C thereinto after removal of the nail or the like, as shown in FIG. 5.

Therefore, in the present invention, the rubber cover layer 9 is formed of rubber having a JIS A hardness X of 50 to 70 as described above, and the thickness Y (mm) is defined as explained above in relation to the hardness X.

If the hardness X is less than 50, or if the thickness Y is in the range below the line expressed by −0.025X+2.25, the rubber cover layer 9 is too low in stiffness, facilitating occurrence of the state shown in FIG. 3A. If the hardness X is greater than 70, or if the thickness Y is in the range above the line expressed by −0.025X+3.05, the rubber cover layer 9 is too high in stiffness, facilitating occurrence of the state shown in FIG. 3B. Preferably, the JIS A hardness X of rubber of the rubber cover layer 9 is 55 to 68, and the thickness Y satisfies the following expression in relation to the hardness X.
−0.025X+2.3≦Y≦−0.025X+3.0

In the present invention, the same rubber compositions as those conventionally used may be used for the rubber composition of the rubber cover layer 9, and there is no particular limitation thereto; examples of the rubber composition preferably include natural rubber, styrene-butadiene rubber, butadiene rubber and the like.

The breaking elongation of rubber of the rubber cover layer 9 according to the tension test (JIS K6251) is preferably 700% or greater, because, when foreign matter such as a nail break through the tread 1 and penetrates into the tire, the rubber cover layer 9 elongates so as to facilitate providing an effect of collecting the sealant of the sealant layer 8 adhering to the radially outer surface (surface on the sealant side) of the rubber cover layer to the vicinity of a part damaged by the foreign matter.

It is preferable that the breaking elongation of rubber of the rubber cover layer 9 be higher; there is no particular limitation to the upper limit thereof.

When the pneumatic tire of the present invention described above is used in cold regions, the rubber cover layer 9 is preferably formed of rubber having a glass transition point of −50.degree. C. or less in terms of provision of an effective function of the rubber cover layer 9. As the glass transition point of rubber of the rubber cover layer 9 is lower, the tire is usable in colder regions, so there is no particular limitation to the lower limit thereof.

### INDUSTRIAL APPLICABILITY

The present invention having the aforementioned excellent effect is very effectively applicable to a pneumatic tire having a function of preventing puncturing thereof.

1. A pneumatic tire having a tread, a sealant layer for prevention of puncturing being provided on an inner surface of the tire in the tread, a rubber cover layer covering a surface of the sealant layer,
wherein the rubber cover layer is formed of rubber having a JIS A hardness X of 50 to 70, and has a thickness Y (mm) satisfying the following expression in relation to the hardness X.
−0.025X+2.25≦Y≦−0.025X+3.05

2. A pneumatic tire according to claim 1, wherein the JIS A hardness X of rubber of the rubber cover layer is 55 to 68, and the thickness Y of the rubber cover layer satisfies the following expression in relation to the hardness X.
−0.025X+2.3≦Y≦−0.025X+3.0

3. A pneumatic tire according to claim 1, wherein the rubber of the rubber cover layer has a breaking tensile elongation that is 700% or greater.

4. A pneumatic tire according to claim 1, wherein the rubber of the rubber cover layer has a glass transition point that is −50 degree. C. or less.
